(19) United States
(12) Patent Application Publication
(10) Pub. No.: US 2017/0264710 A1
(43) Pub. Date: Sep. 14, 2017

(54) COORDINATED THING-SOURCING IN AN INTERNET OF THINGS

(71) Applicant: CA, Inc., New York, NY (US)

(72) Inventors: Victor Muntés Mulero, Barcelona (ES); Steven L. Greenspan, Scotch Plains, NJ (US); Marc Solé Simo, Barcelona (ES)

(73) Assignee: CA, Inc., New York, NY (US)

(21) Appl. No.: 15/069,269

(22) Filed: Mar. 14, 2016

(51) Int. Cl. H04L 29/08

(52) U.S. Cl. CPC H04L 67/327; H04L 67/104; H04L 67/141

(57) ABSTRACT

Requirements for a thing-sourcing project that comprises a thing-sourcing task are posted to thing-sourcing participant devices. Electronic requests are received from a first group of the thing-sourcing participant devices, to participate in the task. The electronic request identifies a portion of the task that can be accomplished by the thing-sourcing participant device, but none of the electronic requests indicate that the task can be accomplished entirely by any one of the thing-sourcing participant devices. A second group of the thing-sourcing participant devices is selected from the first group of the thing-sourcing participant devices. The second group of the thing-sourcing participant devices can collectively accomplish the task, even though none of the second group of the thing-sourcing participant devices can accomplish the task individually. Execution of the thing-sourcing project by the second group of the thing-sourcing participant devices is then coordinated. Related systems, methods and computer program products are provided.

### BACKGROUND

Various embodiments described herein relate to networks of electronic devices, and more particularly to thing-sourcing systems, devices, methods and computer program products.

Crowdsourcing is a type of participative online activity in which an individual or entity proposes to a group of individuals of varying knowledge, heterogeneity, and number, via a flexible open call, the voluntary undertaking of a task. In crowdsourcing, an individual communicates with a crowdsourcing platform via a user device that is connected to a network such as the Internet. Crowdsourcing may be used to obtain needed services, ideas and/or content by soliciting contributions from a large group of people, and especially from an online community.

The Internet of Things (IoT) refers to a network of physical and virtual things having embedded computer systems associated therewith that allow the things to exchange data with other entities, such as a user, operator, manufacturer, technician, analyst, etc. based on the International Telecommunication Union's Global Standards Initiative. The IoT may allow, for example, things to be sensed, monitored, and/or controlled remotely across existing network infrastructure, which may create more opportunities for direct integration between the physical world and computer-based systems, and may result in improved efficiency, accuracy, and economic benefit. Each thing may be uniquely identifiable through its associated embedded computing system and is able to interoperate within the existing Internet infrastructure. Some experts estimate that the IoT will consist of almost 50 billion things by 2020. The things in the IoT can refer to a wide variety of device or object types such as, but not limited to, industrial electronic devices, environmental sensors, security devices, power plant control/monitoring systems, airplane engine and flight control monitoring systems, railway control and monitoring systems, manufacturing control systems, and the like.

### SUMMARY

According to some embodiments described herein, a coordinated thing-sourcing method posts requirements for a thing-sourcing project that comprises a thing-sourcing task to thing-sourcing participant devices. The thing-sourcing participant devices can include individuals that communicate with a thing-sourcing platform via a user device that is connected to a network and the thing-sourcing participant devices can also comprise an electronic device that automatically communicates with the thing-sourcing platform via the network. The electronic device may include a conventional computer system or database management system but can also include an electronic device in the Internet of Things (IoT).

Electronic requests are received from a first group of the thing-sourcing participant devices, to participate in the task. A respective electronic request identifies a portion of the task that can be accomplished by a respective thing-sourcing participant device, but none of the requests indicate that the task can be accomplished entirely by any one of the first group of the thing-sourcing participant devices. A second group of the thing-sourcing participant devices is selected from the first group of the thing-sourcing participant devices. The second group of the thing-sourcing participant devices can collectively accomplish the task, even though none of the second group of the thing-sourcing participant devices can accomplish the task individually. Execution of the thing-sourcing project is then coordinated using the second group of the thing-sourcing participant devices that can collectively accomplish the task, even though none of the second group of the thing-sourcing participant devices can accomplish the task individually.

In some embodiments, the posting of the requirements is performed by a thing-sourcing platform that is connected to the thing-sourcing participant devices via a network such as the Internet. The receiving electronic requests from the first group of the thing-sourcing participant devices is performed by the thing-sourcing platform in response to the electronic requests that are received by the thing-sourcing platform from the first group of the thing-sourcing participant devices over the network. The selecting of the second group of the thing-sourcing participant devices is also performed by the thing-sourcing platform. The coordinating of the thing-sourcing project is performed by the thing-sourcing platform.

In some embodiments, the selecting of the second group of the thing-sourcing participant devices from the first group of the thing-sourcing participant devices comprises identifying a set of conditions that are required to accomplish the task, and identifying respective subsets of the set of conditions that are satisfied by respective thing-sourcing participant devices in the first group of the thing-sourcing participant devices based on the respective portions of the task identified in the respective electronic requests, to identify the second group of the thing-sourcing participant devices that can collectively accomplish the set of conditions even though none of the second group of the thing-sourcing participant devices can accomplish the set of conditions individually. The identifying respective subsets of the set of conditions may include identifying a subset of the set of conditions that is satisfied by a given device in the first group of the thing-sourcing participant devices, determining whether the set of conditions is satisfied by the given device and any previously identified device(s) in the first group of the thing-sourcing participant devices, and performing the identifying and the determining for additional devices in the first group of the thing-sourcing participant devices until the second group of the thing-sourcing participant devices has been identified.

The identifying respective subsets of the set of conditions may further include identifying largest subsets of the set of conditions that are satisfied by the respective thing-sourcing participant devices in the first group of the thing-sourcing participant devices, to eliminate a member of the second group of the thing-sourcing participant devices that can only satisfy a smaller subset of the set of conditions.

The identifying of subsets of the set of conditions may be terminated in response to the second group of the thing-sourcing participant devices being identified, even though the conditions that are satisfied by all of the first group of the thing-sourcing participant devices have not yet been identified. Moreover, after identifying the second group of the thing-sourcing participant devices, the members of the first group of the thing-sourcing participant devices that are not included in the second group of the thing-sourcing participant devices may be notified that they will not be participating in the thing-sourcing project.

In some embodiments, the coordinating execution of the thing-sourcing project using the second group of the thing-sourcing participants may comprise identifying a plurality of subworkflows that are to be performed by respective thing-sourcing participant devices in the second group of the thing-source participant devices to accomplish the thing-sourcing task; notifying the respective thing-sourcing participant devices in the second group of the thing-sourcing participant devices, of a respective subworkflow that is to be performed; receiving over the network from the respective thing-sourcing devices of the second group of thing-sourcing participant devices, respective results of performing the respective subworkflow; and combining results from the second group of the thing-sourcing participant devices. In some embodiments, the notifying may comprise allocating memory and processor resources of the thing-sourcing platform based on the respective subworkflows that are to be performed.

In some embodiments, the posting is performed by the thing-sourcing platform in response to electronic input from a requestor device over the network.

In some embodiments, the receiving and the selecting are performed to overlap in time, at least partially. Moreover, the receiving may be terminated upon completion of the selecting, so that no further electronic requests to participate are processed.

In some embodiments, at least one of the thing-sourcing participant devices comprises a user device that communicates with the thing-sourcing platform over the network in response to user input. Moreover, at least one of the thing-sourcing participant devices comprises an electronic device that automatically communicates with the thing-sourcing platform over the network. In some embodiments the electronic device comprises a thing in an Internet of Things (IoT). Also, in some embodiments the electronic device automatically communicates with the thing-sourcing platform via the network using a software agent that is configured to negotiate with the thing-sourcing platform, the portion of the task that can be accomplished by the electronic device.

Other embodiments described herein include a computer program product that includes a computer readable storage medium having computer readable program code embodied in the medium. The computer code is executable to cause a computer system to perform operations comprising posting requirements for a thing-sourcing project that comprises a thing-sourcing task, to thing-sourcing participant devices; receiving from a first group of the thing-sourcing participant devices, electronic requests to participate in the task, wherein a respective electronic request identifies a portion of the task that can be accomplished by a respective thing-sourcing participant device, but none of the electronic requests indicate that the task can be accomplished entirely by any one of the first group of the thing-sourcing participant devices; selecting from the first group of the thing-sourcing participants devices, a second group of the thing-sourcing participant devices that can collectively accomplish the task, even though none of the second group of the thing-sourcing participant devices can accomplish the task individually; and coordinating execution of the thing-sourcing project by the second group of the thing-sourcing participant devices that can collectively accomplish the task, even though none of the second group of the thing-sourcing participant devices can accomplish the task individually. Other operations according to any of the embodiments described above may also be performed.

Yet other embodiments described herein may also be directed to computer systems that include a processor and a memory coupled to the processor. The memory may include computer readable program code embodied therein that is executable to cause the computer system to perform operations comprising posting requirements for a thing-sourcing project that comprises a thing-sourcing task, to thing-sourcing participant devices; receiving from a first group of the thing-sourcing participant devices, electronic requests to participate in the task, wherein a respective electronic request identifies a portion of the task that can be accomplished by a respective thing-sourcing participant device, but none of the electronic requests indicate that the task can be accomplished entirely by any one of the first group of the thing-sourcing participant devices; selecting from the first group of the thing-sourcing participant devices, a second group of the thing-sourcing participant devices that can collectively accomplish the task, even though none of the second group of the thing-sourcing participant devices can accomplish the task individually; and coordinating execution of the thing-sourcing project using the second group of the thing-sourcing participant devices that can collectively accomplish the task, even though none of the second group of the thing-sourcing participant devices can accomplish the task individually. Other operations according to any of the embodiments described above may also be performed.

It is noted that aspects described herein with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

Aspects described herein are illustrated by way of example and are not limited by the accompanying figures, with like references indicating like elements.

FIG. 1 is a block diagram of a thing-sourcing environment for coordinating thing-sourcing according to various embodiments described herein.

FIG. 2 is a flowchart of operations that may be performed by a thing-sourcing platform, such as the thing-sourcing platform of FIG. 1, according to various embodiments described herein.

FIG. 3 schematically illustrates thing-sourcing participant devices including first and second groups thereof according to various embodiments described herein.

FIG. 4 is a flowchart of operations that may be performed to incorporate coordinated thing-sourcing with conventional thing-sourcing according to various embodiments described herein.

FIG. 5 is a flowchart of operations that may be performed to select from the first group of the thing-sourcing participant devices, a second group of the thing-sourcing participant devices that can collectively accomplish the task, according to various embodiments described herein.

FIG. 6 is a flowchart of operations that may be performed to execute a thing-sourcing project according to various embodiments described herein.

FIG. 7 is a block diagram of a generic architecture for a thing-sourcing platform that may be modified to perform coordinated thing-sourcing according to various embodiments described herein.

FIG. 8 illustrates an example where a particular task may be satisfied by two participant devices according to various embodiments described herein.

FIG. 9 is a flowchart of high-level operations of coordinated thing-sourcing according to various embodiments described herein.

FIG. 10 illustrates another example of a task that can be performed by multiple participant devices according to various embodiments described herein.

### DETAILED DESCRIPTION

Various embodiments described herein may arise from recognition that crowdsourcing may be extended to “thing-sourcing”, wherein thing-sourcing participants can include individuals that communicate with a thing-sourcing platform via a user device that is connected to a network and the thing-sourcing participants can also comprise an electronic device that automatically communicates with the thing-sourcing platform via the network. The electronic device may include a conventional computer system or database management system but can also include an electronic device in the Internet of Things (IoT).

Various embodiments described herein may also arise from recognition that it may be highly desirable to allow information from large numbers of IoT things to participate in thing-sourcing projects, along with individuals. However, each thing typically provides specialized data or information, so that it is extremely unlikely that a given thing can accomplish a task by itself. Moreover, the extremely large number of things that are expected to be present in the IoT makes it extremely difficult to catalog and identify potential candidate things for participating in a thing-sourcing project.

Various embodiments described herein can overcome these potential difficulties by allowing thing-sourcing participant devices to request to participate in a task even though an individual thing-sourcing participant device cannot accomplish the task by itself. Based on the requests that are received, a subset of the thing-sourcing participant devices is selected that can collectively accomplish the task, even though none of the selected thing-sourcing participant devices can accomplish the task individually. The task is then accomplished collectively by coordinating the efforts of the selected thing-sourcing participant devices, to each perform part of the task, even though none of the selected participant devices can accomplish the task individually.

Various embodiments described herein may be contrasted with dividing a task into subtasks to effectuate crowdsourcing. In dividing a task, it is known that the task cannot be accomplished without dividing the task into subtasks, due to the known capabilities of the crowdsourcing participants. The task is therefore divided into subtasks and each subtask is then performed by one or more crowdsourcing participants. In sharp contrast, in various embodiments described herein, the capabilities of the large number of things is generally unknown, so that it cannot be determined beforehand whether any given thing can accomplish the task. Thus, the requirements for the task are posted, and requests to participate in the task are received from devices that can only accomplish a portion of the task. The devices are then selected based on assembling a group of devices that can collectively accomplish the task, even though none of the devices can accomplish the task individually.

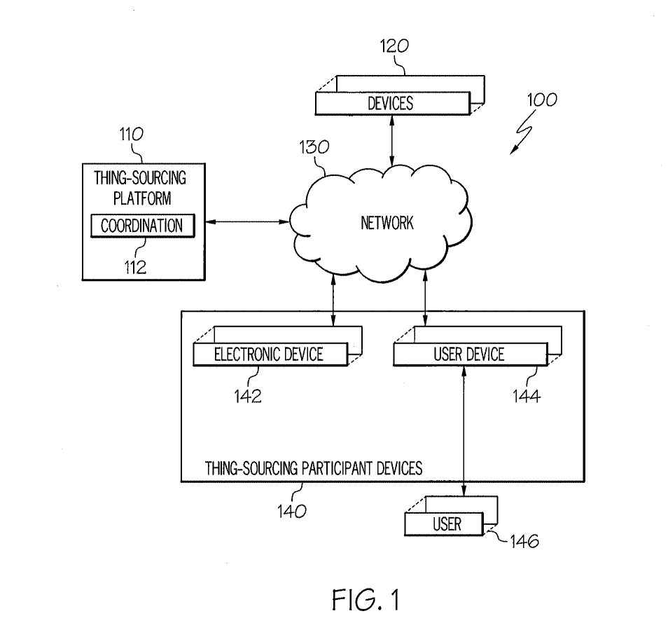

FIG. 1 is a block diagram of a thing-sourcing environment 100 for coordinating thing-sourcing according to various embodiments described herein. Referring now to FIG. 1, a thing-sourcing platform 110 is provided. The thing-sourcing platform 110 may be embodied as one or more enterprise, application, personal, pervasive and/or embedded computer systems that are operable to receive, transmit, process and/or store data using any suitable combination of software, firmware and/or hardware and that may be stand-alone or interconnected by any conventional public and/or private, real and/or virtual, wired and/or wireless network including all or a portion of the global communication network known as the Internet, and may include various types of tangible, non-transitory computer readable media. A more detailed embodiment of a thing-sourcing platform will be provided below.

The thing-sourcing platform 110 may include a coordination system, method and/or computer program product, collectively referred to herein as a “coordination module” 112, that can be used to coordinate thing-sourcing according to various embodiments described herein. The thing-sourcing platform 110 communicates with a plurality of requestor devices 120 and a plurality of thing-sourcing participant devices 140 over a network 130. The network 130 may be any conventional public and/or private, real and/or virtual, wired and/or wireless network including all or a portion of the Internet.

Still referring to FIG. 1, the plurality of requestor devices 120 communicate with the thing-sourcing platform 110 via the network 130. A given requestor device requests a thing-sourcing project from the thing-sourcing platform 110 by providing various information about the thing-sourcing project. In some embodiments, the requestor device 120 may define a task using a particular formal language and/or natural language. The requestor device may be responsive to a user (individual) that requests a task via a user device, an entity that requests a task and/or a computer system that requests a task.

Still referring to FIG. 1, a plurality of thing-sourcing participant devices 140 also communicate with the thing-sourcing platform 110. The thing-sourcing participant devices include a plurality of user devices 144, that communicate with the thing-sourcing platform 110 over the network 130, in response to input from users (individuals) 146, and also include a plurality of electronic devices 142 that automatically communicate with the thing-sourcing platform 110 via the network 130. A given user 146 may be associated with one or more user devices 144, and a given user device 144 may be associated with one or more users 146.

The user devices 144 may be embodied by mobile phones, tablets, laptop/desktop computers, and/or any other devices that are configured to provide an interface for connection to a network under control of a user 146. The electronic devices 142 may comprise things in the IoT. As used herein, a “thing,” when referred to in context of the IoT, is an object of the physical world (physical thing) or an object of the information world (virtual thing), which is capable of being identified and integrated into a communication network. Things have associated information, which can be static and dynamic. A physical thing may be capable of sensing and/or may be capable of being actuated, and may be capable of being connected. Examples of physical things include, but are not limited to, an electronic sensor, a robot, a good, a product, and a piece of electrical equipment. A virtual thing may be capable of being stored and/or may be capable of being processed, and may be capable of being accessed. Examples of virtual things include, but are not limited to, multimedia content, application software stored in a memory and executed by a processor and a database management system.

The electronic devices 142 are configured to automatically communicate with the thing-sourcing platform 110 via the network 130 and may be embodied by one or more enterprise, application, personal, pervasive and/or embedded computer systems that are operable to receive, transmit, process and/or store data using any suitable combination of software, firmware, and/or hardware, and that may be stand-alone or interconnected by any conventional public and/or private, real and/or virtual network, wired and/or wireless network including the Internet, and may include various types of tangible, non-transitory computer readable medium. Moreover, in some embodiments, the electronic device 142 may communicate with the thing-sourcing platform 110 via the network 130 using a software agent that is included in the electronic device 142, in the thing-sourcing platform 110, and/or elsewhere in the thing-sourcing environment 100, and that is configured to negotiate with the thing-sourcing platform 110, the portion of the task that can be accomplished by the electronic device 142, credentials of the electronic device 142 and/or capabilities thereof.

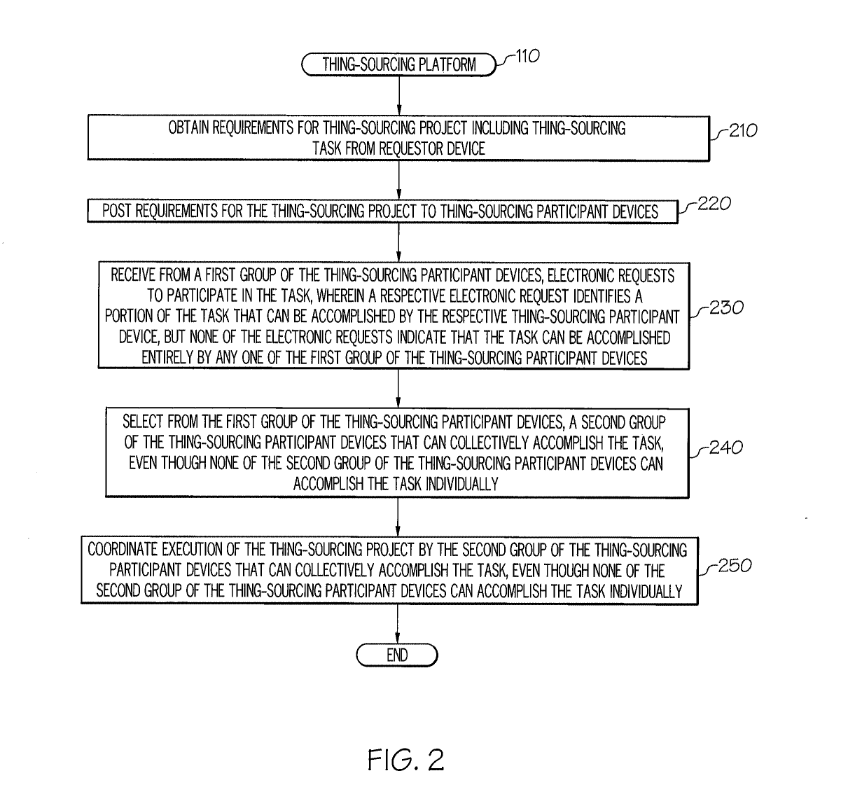

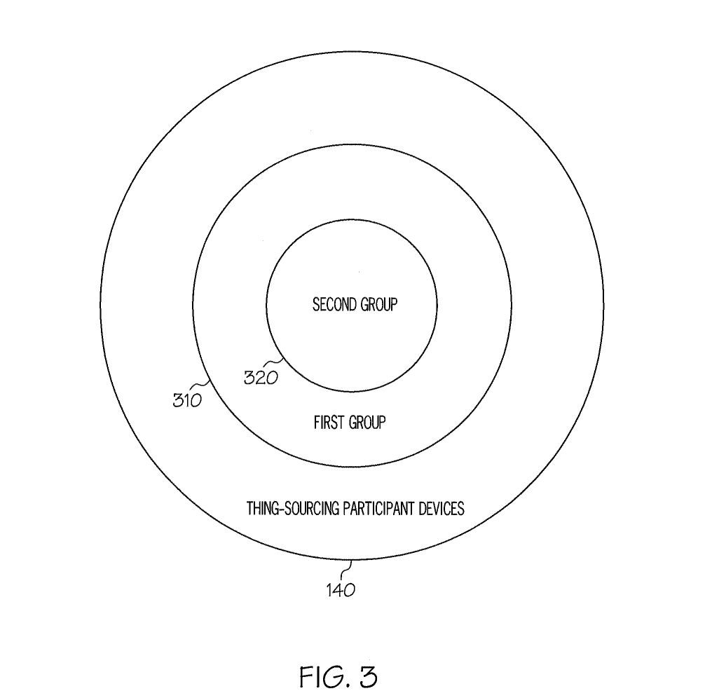

FIG. 2 is a flowchart of operations that may be performed by a thing-sourcing platform, such as the thing-sourcing platform 110 of FIG. 1, including the coordination module 112 of FIG. 1, according to various embodiments described herein. Referring to FIG. 2, at Block 210 requirements for thing-sourcing project that includes a thing-sourcing task are obtained from a requestor device, such as a requestor device 120 of FIG. 1, by the thing-sourcing platform 110 over the network 130. At Block 220, requirements for the thing-sourcing project are posted to the thing-sourcing participant devices 140 by the thing-sourcing platform 110. There may be many embodiments of posting. In some embodiments, the posting takes place at the thing-sourcing platform 110 itself and the thing-sourcing participant devices 140 access the thing-sourcing platform 110 over the network 130 to determine which thing-sourcing projects are available to them. In other embodiments, the thing-sourcing platform 110 may broadcast information about the thing-sourcing project to the participant devices 140 over the network 130. Combinations of these and other techniques may also be used. Referring briefly to FIG. 3, the largest circle indicates the set of thing-sourcing participant devices 140 to whom the requirements for the thing-sourcing project are posted at Block 220.

Referring again to FIG. 2, at Block 230, electronic requests to participate in the task are received from a first group of the thing-sourcing participant devices 140, labeled 310 in FIG. 3. A respective electronic request identifies a portion of the task that can be accomplished by the respective thing-sourcing participant device 140. However, none of the electronic requests indicate that the task can be accomplished entirely by any one of the first group 310 of the thing-sourcing participant devices 140.

Still referring to FIG. 2, a second group (labeled 320 in FIG. 3) of the thing-sourcing participant devices 140 is selected from the first group 310 of the thing-sourcing participant devices 140, at Block 240. The second group 320 of the thing-sourcing participant devices 140 can collectively accomplish the task even though none of the second group 320 of the thing-sourcing participant devices 140 can accomplish the task individually. Specific examples will be provided below.

Finally, at Block 250, execution of the thing-sourcing project is coordinated using the second group 320 of the thing-sourcing participant devices 140 that can collectively accomplish the task, even though none of the second group 320 of the thing-sourcing participant devices 140 can accomplish the task individually.

It will be understood that in FIG. 2, the selection of the second group 320 from the first group 310 at Block 240 is performed after receiving all of the requests from the first group 310 at Block 230. However, this need not be the case. Specifically, in some embodiments, the receiving of Block 230 and the selecting of Block 240 may overlap at least partially in time. Thus, for example, as the electronic requests are received from the first group 310 at Block 230, they may be evaluated for inclusion or exclusion in the second group 320. Then, once the second group 320 has been selected, further receiving of electronic requests from the first group 310 may be terminated. Thus, the selecting of the second group may 320 begin before all of the electronic requests to participate have been received from the first group 310.

It will also be understood that operations of Blocks 230, 240 and 250 may be performed by the coordination module 112 of FIG. 1 in some embodiments. In other embodiments however, only a subset of Blocks 230, 240 and/or 250 are performed by the coordination module 112, with the remaining operations being performed by other elements of the thing-sourcing platform 110.

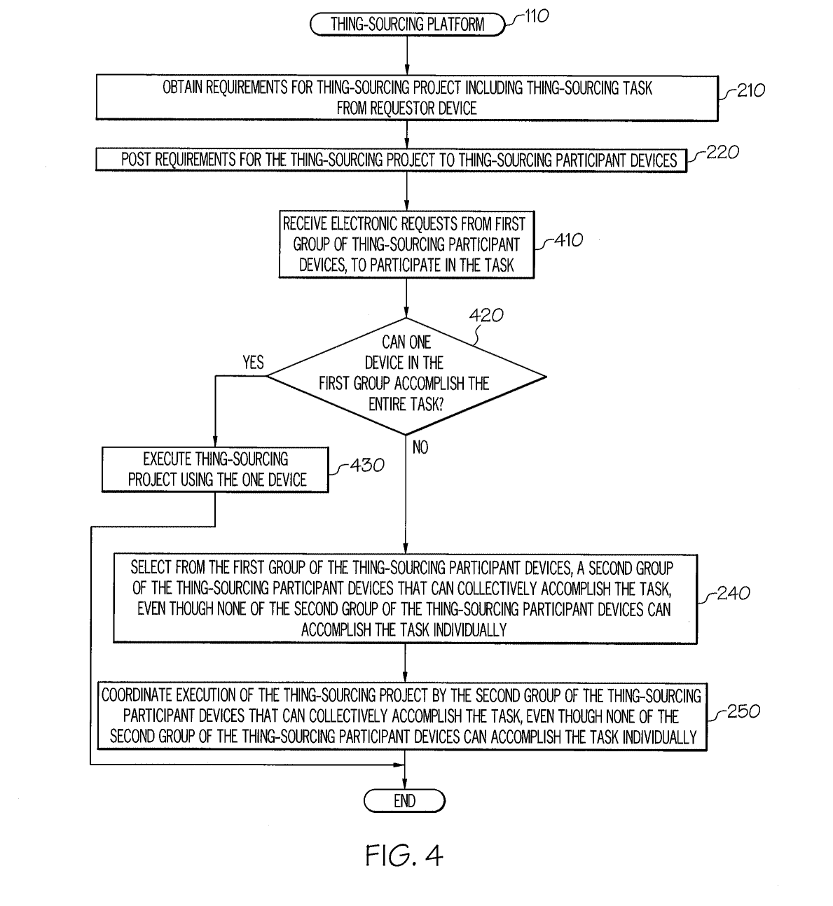

FIG. 4 is a flowchart of operations that may be performed to combine coordinated thing-sourcing and conventional thing-sourcing according to various embodiments described herein. Referring to FIG. 4, after the operations of Blocks 210 and 220 are performed, electronic requests are received from a first group 310 of the thing-sourcing participant devices 140 to participate in the task, at Block 410. A test is then made at Block 420 as to whether any one device in the first group 310 can accomplish the entire task. If yes, then the thing-sourcing project is executed using the one device at Block 430. If no, operations of Blocks 240 and 250 are performed to select the second group 320 from the first group 310 and to coordinate execution of the thing-sourcing project by the second group 320.

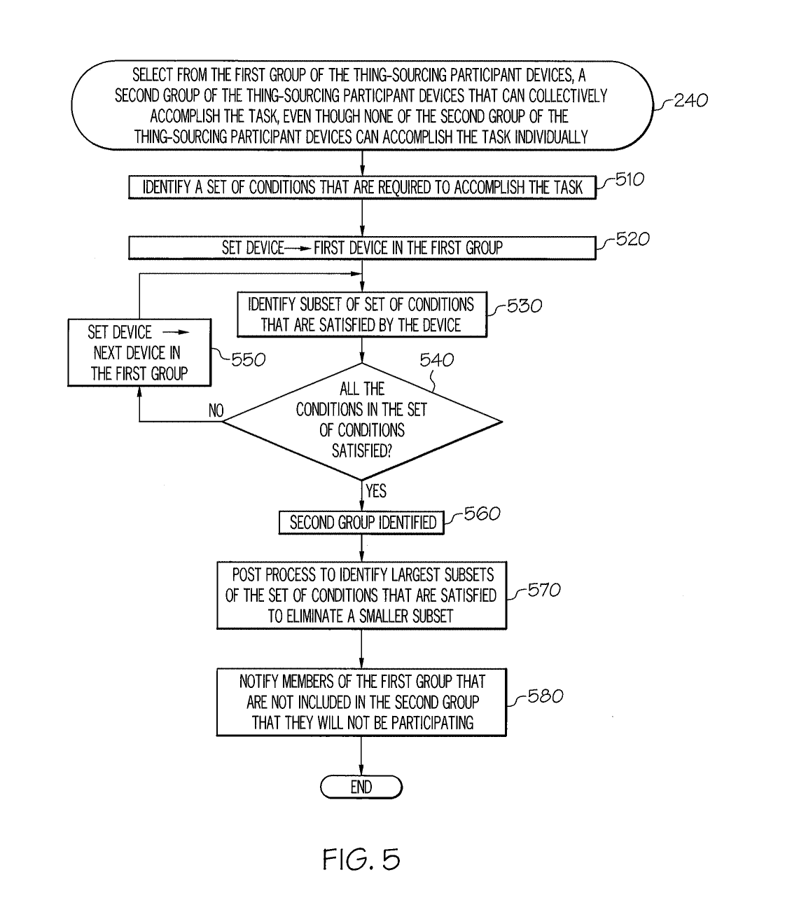

FIG. 5 is a flowchart of operations that may be performed to select from the first group 310 of the thing-sourcing participant devices 140, a second group 320 of the thing-sourcing participant devices 140 that can collectively accomplish the task, according to various embodiments described herein, and may correspond to the operations of Block 240 of FIGS. 2 and 4.

Referring to FIG. 5, at Block 510, a set of conditions that are required to accomplish the task is identified. The set of conditions may include requirements, qualifications and/or other criteria that are required to accomplish the task. At Block 520, a first device of the first group 310 is examined. At Block 530, a subset of the set of conditions that are satisfied by the first device is identified based on, for example, content of the electronic request that was received from the first device. A test is made at Block 540 as to whether all of the conditions in the set of conditions have been satisfied by the device(s) that have been examined at Blocks 520 and 530. If not, the next device in the first group 310 is examined at Block 550, and the operations of Blocks 530, 540 and 550 continue to be performed until all of the conditions in the set of conditions have been satisfied at Block 540. This indicates that the second group 320 has been identified at Block 560.

The operations of Block 540 may keep track of a “best offer” so far and/or keep a sorted list of received device offerings, so that if nothing better is available, the request conditions can be downgraded, if necessary. This may depend on how the conditions are specified at Block 510. For example, some conditions may provide a desired degree of precision and/or a desired time of completion. If, after this time of completion, no feasible subgroup can provide the information, the precision constraint may be dropped or relaxed. Moreover, if no group can provide the required precision, traditional crowdsourcing may be used to try to collect equivalent results.

Accordingly, various operations illustrated in FIG. 5 can identify respective subsets of the set of conditions that are satisfied by respective thing-sourcing participant devices in the first group 310 of the thing-sourcing participant devices 140 based on the respective portions of the task identified in the respective electronic requests, to identify the second group 320 of the thing-sourcing participant devices 140 that can collectively accomplish the set of conditions even though none of the second group 320 of the thing-sourcing participant devices 140 can accomplish the set of conditions individually. FIG. 5 also illustrates embodiments wherein the identifying respective subsets comprises identifying a subset of the set of conditions that is satisfied by a given device in the first group 310 of the thing-sourcing participant devices 140 (Block 530), determining whether the set of conditions is satisfied by the given device and any previously identified device(s) in the first group 310 of the thing-sourcing participant devices 140 (Block 540), and performing the identifying (Block 530) and the determining (Block 540) for additional participant devices (Block 550) in the first group 310 of the thing-sourcing participant devices 140, until the second group 320 of the thing-sourcing participant devices 140 has been identified (Block 560).

Moreover, as illustrated in FIG. 5 at Block 540, the identifying respective subsets is terminated in response to the second group 320 of the thing-sourcing participant devices 140 being identified, even though the conditions that are satisfied by all of the first group 310 of the thing-sourcing participant devices 140 have not yet been identified. In other embodiments, however, the thing-sourcing participant devices 140 can continue to be examined, for example to determine if a single device may be found later that can satisfy the entire task.

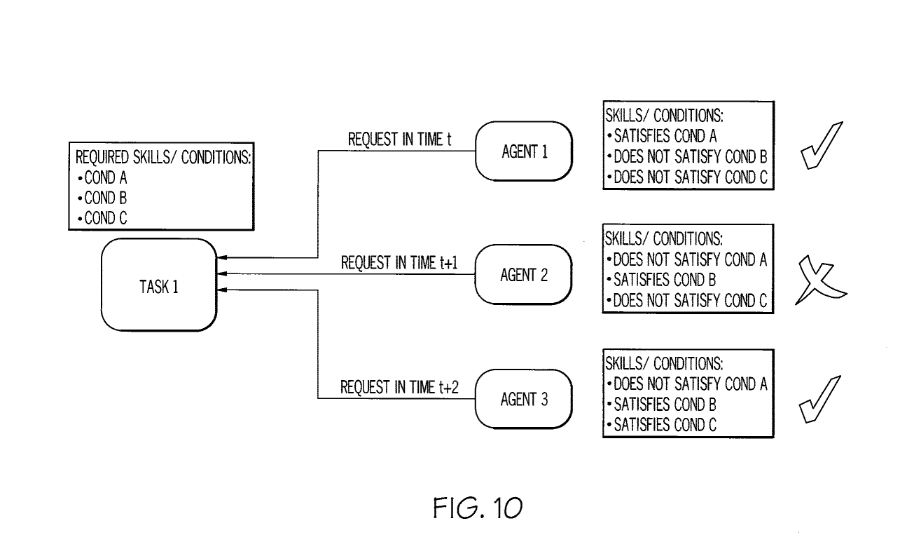

Still referring to FIG. 5, at Block 570, post-processing may be performed to identify largest subsets of the set of conditions that are satisfied by the respective thing-sourcing participant device in the first group 310 of the thing-sourcing participant devices 140, to eliminate member(s) of the second group 320 of the thing-sourcing participant devices 140 that can only satisfy smaller subset(s) of the set of conditions. For example, the second group 320 that was identified in Block 560 may include ten participants who collectively can satisfy all of the conditions in the set of conditions that are required to accomplish the task, even though none of the second group 320 of the thing-sourcing participant devices 140 can accomplish the set of conditions individually. However, further analysis of the second group 320 may determine that two of the ten members of the second group 320 only accomplish a small number of the tasks, and these tasks are also accomplished by the eight other members of the second group 320. Thus, these two members of the second group 320 can be eliminated and the remaining eight members of the second group 320 can still collectively accomplish the set of conditions. A specific example will be provided below in connection with FIG. 10.

Finally, optionally, at Block 580 the members of the first group 310 of the thing-sourcing participant devices 140 that are not included in the second group 320 of the thing-sourcing participant devices 140 may be notified that they will not be participating in the thing-sourcing project. Notification may take place by broadcasting by the thing-sourcing platform 110 and/or by posting at the thing-sourcing platform 110.

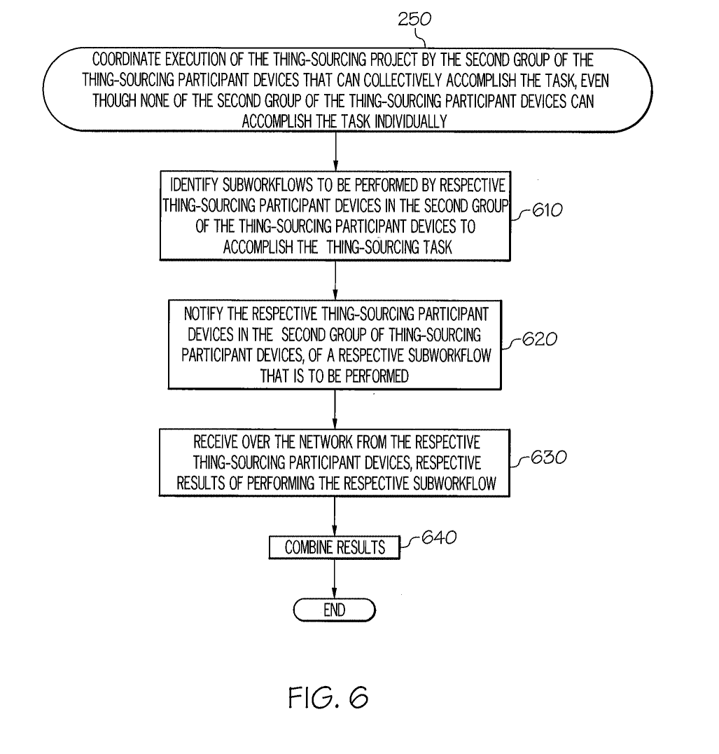

FIG. 6 is a flowchart of operations that may be performed to coordinate execution of the thing-sourcing project, which may correspond to Block 250 of FIGS. 2 and 4. Referring to FIG. 6, at Block 610, a plurality of subworkflows that are to be performed by the respective thing-sourcing participant devices in the second group 320 of the thing-sourcing participant devices 140 to accomplish the thing-sourcing task, are identified. At Block 620, the respective thing-sourcing participant devices in the second group 320 of the thing-sourcing participant devices 140 are notified of their respective subworkflow that is to be performed. For example, as a result of the operations of, for example FIG. 5, the members of the second group 320 may be identified and the particular conditions to be performed by the respective members may also be identified. The conditions also may need to be performed in a given sequence. Thus, at Block 620, each member of the second group 320 is notified of the subworkflow, i.e., the conditions, timing, etc., that is to be performed by the given thing-sourcing participant device 140 so as to collectively accomplish the task.

At Block 630, respective results of performing the respective subworkflow are received over the network from the respective thing-sourcing participant devices in the second group 320 of the thing-sourcing participant devices 140. The results from the second group 320 of the thing-sourcing participant devices 140 are then combined at Block 610 and may be provided to the requestor device 120. The combining may be performed based on the subworkflows that were generated to collectively perform the thing-sourcing task.

Additional discussion of various embodiments described herein will now be provided.

As was previously described, various embodiments described herein can allow devices, directly or using software agents or brokers representing the devices, to accept a task even when the device can only partially solve the task. The device software agent can communicate and collaborate with other devices/software agents to completely solve the task.

More specifically, as the IoT market grows, a very large number of devices may be connected to digital ecosystems. In these digital ecosystems or platforms, services will be offered based on the capacity of these devices to provide specific data and/or their capacity to perform specific actions. These ecosystems will grow with human beings connected and interacting with these devices. With this, service features may be augmented with human capacity, allowing for outsourcing tasks requiring creativity. Thing-sourcing (analogously to crowdsourcing) is the action of solving tasks combining human beings and device capacity in such ecosystems.

As the devices connected to this complex ecosystem grow in number, diversity and capacity to solve tasks, it may become increasingly difficult to know what devices are available to solve a particular problem. Although there have been some attempts to provide catalogs with available devices and their skills or capabilities, and publish/subscribe (pub/sub) models are used in order to match tasks to be solved with devices in the system that can solve them, no mechanisms appear to be available that provide universal visibility of all the devices that are connected. Moreover, when combining devices and human beings, this problem becomes even more difficult. While a global view of the whole system and their devices may not be possible yet, each device may know other devices that can perform actions or provide particular data to solve a task. However, no mechanisms appear to be available that allow for leveraging this knowledge.

Moreover, even if a global catalog was available, thing-sourced tasks may require a device with several different skills to solve them. In case this device is not available at that particular moment, the task may not be able to be solved. Although the task can be split into subtasks to solve this problem, at task definition time the requester generally does not know the availability of resources in the future and, therefore, it is difficult, and may not be possible, to split a task at design time according to resource availability.

Thus, in general, there may be a mismatch between available tasks and the skills required for the devices available to solve that task. As a consequence, tasks that could be split for a group of devices to solve them in a collaborative way, may remain blocked by the system, waiting for a device for the whole set of skills to be available.

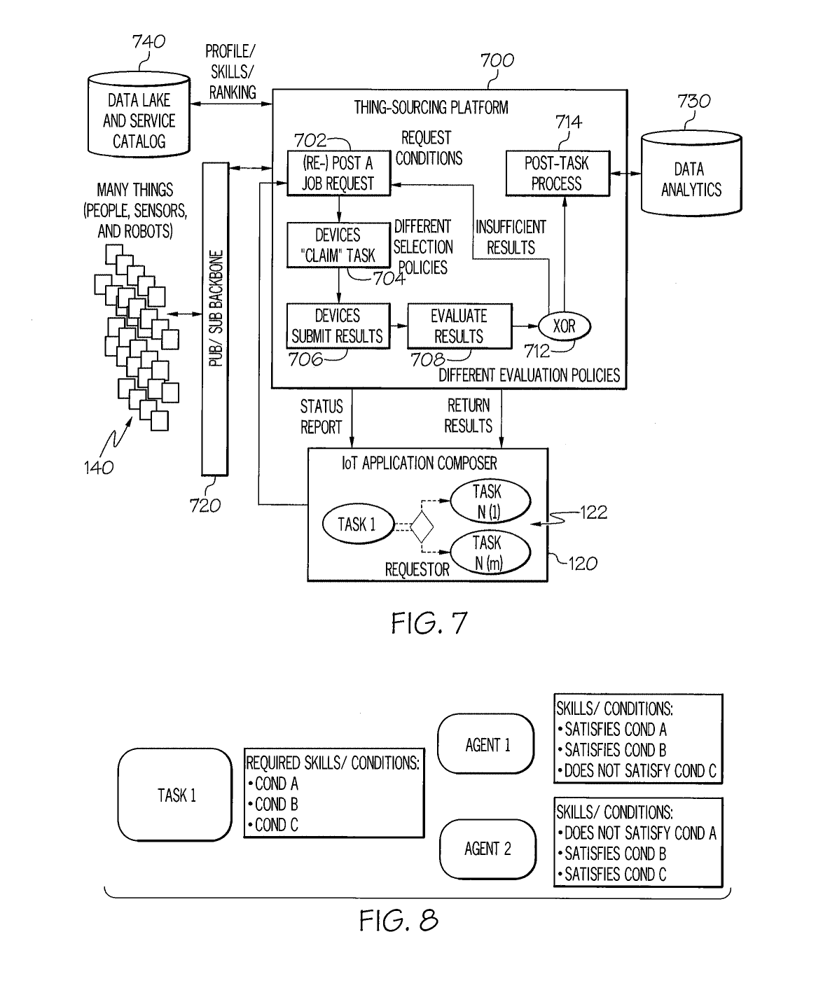

FIG. 7 depicts a generic architecture for a thing-sourcing platform 700 that can be modified to provide collaborative thing-sourcing according to various embodiments described herein. Analogously to a crowdsourcing platform, in a thing-sourcing platform 700 a requester 120 defines a task 122 using a particular formal language and/or natural language. The task 122 is published as an open call by Block 702 and it is made available to thing-sourcing participant devices 140 in a connected ecosystem using a pub/sub backbone 720. This connected ecosystem may also be called the Internet of Things. Thing-sourcing may also be called hybrid crowdsourcing in other contexts.

The concept of worker requirement in a crowdsourced task has been defined as a set of constraints on the group of individuals allowed to choose a certain task. Constraints are defined over any property of the profile of individuals (such as ratio of approved contributions, knowledge about a topic, age, gender and/or location), belonging to a group of individuals, or any combination (using conjunctions, disjunctions or negations). The same definition is used herein but is extended to electronic devices in a hybrid system where both human beings (via user devices) and electronic devices may collaborate together to solve a particular task. These user devices and electronic devices may also be collectively referred to as “agents”. A property of the profile of an agent may be information about their skills, location, data quality, scores about the quality provided in previous task-solving processes, etc.

A complex problem may be divided by the requester device 120 as a composition of tasks 122 or a workflow. These tasks 122 are published by Block 702 through open calls. While previous approaches may limit tasks to agents with particular skills, according to various embodiments described herein this condition may be relaxed to allow an agent that may not be prepared to solve a particular task individually to request the task to solve it collaboratively with other agents.

Still referring to FIG. 7, the thing-sourcing platform 700 also includes a Block 704 wherein devices may claim a task and a Block 706 where they may submit results. The results may provide a status report to the requestor 120. At Block 708, the results are evaluated and the results may be returned to the requestor 120. Block 712 determines whether the results are sufficient. If not, a job request may be reposted to Block 702. If the results are sufficient, post-task processes may be implemented at Block 714, for example using data analytics 730. The thing-sourcing platform may also rely on a data lake and service catalog 740 to obtain profiles, skills and rankings for the agents.

FIG. 8 illustrates an example where a particular task (“Task 1”) has been published and different conditions (“Cond A-C”) are required for the agent that solves that task. A set of agents (2 in the example) is also illustrated, where none of them can solve the task individually, but all together are compliant with the requirements.

Various embodiments described herein can allow different agents to request the task, for example at Block 230 of FIG. 2, until all requirements/conditions are met, for example at Block 240 of FIG. 2. Afterwards, the task is assigned to that particular group of agents, for example at Block 250 of FIG. 2. Thus, various embodiments described herein can crowdsource to the group the responsibility to split a particular task into subtasks.

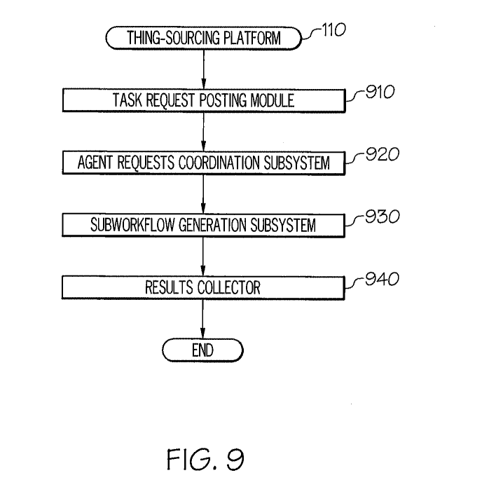

FIG. 9 depicts a high-level architecture of various embodiments described herein. This architecture may be embodied by the thing-sourcing platform 110 of FIG. 1 and/or by modifying Blocks 702-706 of FIG. 7.

Referring to FIG. 9, a task request posting module 910 provides a subcomponent that allows posting of task requests. These tasks may be expressed in different languages, including natural language. This module may also correspond to Block 702 of FIG. 7.

An agent requests coordination subsystem 920 supports the creation of a group to solve a specific task. In particular, the subsystem 920 can accept agents that can solve the full task or that may be able to contribute to the task partially, as was described, for example, in connection with FIG. 4. As was also illustrated in FIG. 2, it is assumed that each task may include a set of conditions related to the skills and/or characteristics agents must satisfy to complete the task. Once a number of different agents cover all the conditions required by a particular task (Block 240 of FIG. 2), this group of agents (if more than one) takes the responsibility to execute that task in a collaborative way (Block 250 of FIG. 2).

The following Table is an example of operations to coordinate the creation of the group of agents necessary to solve a particular task T. The operations return a subset of agents that requested to solve this task and, as a team, fulfill all the conditions defined by the requester. This subset of agents was previously referred to as the second group 320. Accordingly, the operations of the Table may provide an embodiment of coordination module 112 of FIG. 1, a modification of Block 704 of FIG. 7, and/or an embodiment of FIGS. 2, 4 and/or 5. The “candidate agents” correspond to the “first group” 310 that was previously described, and the returned “A_{Cand}” corresponds to the “second group” 320.

TABLE
Example of Collaborative Agents Team Creation algorithm

| | | |
|---|---|---|
| 1: | A_{Cand} := Ø | [symbol] List of candidate agents willing to (partially) solve a task |

| 2: | C_{T} := {c₁, ..., cₙ} [symbol] Set of conditions required to agents willing to solve task T | |
|---|---|---|
| 3: | Cₗ:= C_{T} | [symbol] List of conditions pending to be satisfied |

| | |
|---|---|
| 4: | publish(T) |
| 5: | listenRequestChannel( ); |
| 6: | while Cₗ ≠ Ø do |

| | | |
|---|---|---|
| 7: | for all a requesting task T do | [symbol] Per each agent requesting T |

| | | |
|---|---|---|
| 8: | if Cₐ ∩ Cₗ ≠ Ø then | [symbol] Cₐ: conditions satisfied by agent a |

| 9: | Cₗ := Cₗ \ Cₐ | |
|---|---|---|
| 10: | A_{Cand} := A_{Cand} ∪ {a} | [symbol] Add new agent to the team |

| | |
|---|---|
| 11: | else |

| | |
|---|---|
| 12: | reject(a) |

| | |
|---|---|
| 13: | end if |

| | |
|---|---|
| 14: | end for |

| | |
|---|---|
| 15: | end while |
| | return A_{Cand} |

Returning to FIG. 9, the coordination subsystem 920 may also exclude agents that are no longer necessary in the group, as was illustrated, for example, at Block 580 of FIG. 5. For instance, FIG. 10 illustrates an example where Agent 1 requests Task 1 to the Task 1 agent. Agent 1 is accepted temporarily as it satisfies one out of the three conditions related to Task 1. Then, Agent 2 requests to participate and it is also temporarily accepted. Finally, Agent 3 requests to participate. Since Agent 3 satisfies two out of the three conditions, and in particular it also covers those conditions satisfied by Agent 2, Agent 2 is no longer necessary and can be excluded from the final group. Thus, FIG. 10 provides an example of the operations of Block 570 of FIG. 5. The coordination subsystem 920 may also use other mechanisms to exclude unnecessary agents from the final selection.

Returning again to FIG. 9, a subworkflow generation subsystem 930 is also provided. Once the group of agents responsible for solving a particular task is created, it may be necessary to refine the general workflow, as a particular task of this workflow may need to be divided into smaller subtasks, workload may need to be distributed and work coordinated among agents. Accordingly, the subworkflow generation subsystem 930 may provide an embodiment of Block 250 of FIGS. 2 and 4.

Different mechanisms for workflow creation may be used. This may strongly depend on the language used to express the task. For procedural languages, there may be mechanisms to translate tasks into workflows automatically following a rule-based approach. For functional languages, this may also be done through rules. For natural language, this may use other sophisticated mechanisms, based, for example, on text mining and automatic concept extraction.

Finally, a results collector 940 collects results generated after agents execute the workflow, as was described, for example, at Blocks 706 and 708 of FIG. 7.

It will be understood that various embodiments have been described herein in connection with thing-sourcing, where the thing-sourcing participants 140 include electronic devices 142 and user devices 144. However, other embodiments described herein may be used for crowdsourcing, wherein all of the crowdsourcing participants comprise user devices 144 that are operated by individual users and do not include electronic devices 142 that operate automatically.

### Example

The following example shall be regarded as merely illustrative and shall not be construed as limiting.

A mobility application may require collecting environmental data to provide recommendations to the inhabitants of a particular city related to the best way to go from a point A in the city to a point B in the same city. Different alternatives may include using public transportation, a private vehicle or even a shared vehicle system. A recommendation may be affected by many different conditions including weather conditions, status of traffic at the time of travelling, current position of the different public transportation vehicles and time to pick up, pollution conditions in the city, number of people planning to use the same means of transportation at the same time, etc. The application may be connected to a thing-sourcing platform to collect the information required to provide recommendations. For instance, at development time, application developers may generate tasks in the form of data queries to be posted in the thing-sourcing platform. One task performed by the mobility application may involve asking to a particular device information about the humidity, pressure and temperature in a particular area. Another task performed by the mobility application may be asking the different bus stops equipped with sensors where is the bus the user needs to get to a particular place. Another task may be collecting information about the particular pollution in a particular area. Another task performed by the mobility application may be asking for the number of people in a particular bus stop and/or the number of people in a particular bus. With this information, the mobility application may know if weather conditions make it comfortable for the user to wait in a bus stop. In case of doubt, it may also take into consideration how long it would take for the next bus to get the bus stop required by the user, whether the user will fit in the next bus or the user will need to wait for the next one, and according to pollution measurements, the mobility application may promote or discourage the user from using a private vehicle.

At development time, it is not known if there is a meteorological station in the area able to provide information about humidity, pressure, temperature or even levels of pollution, for instance. It may happen that a developer of the mobility application is aware of a system that provides a network of devices able to collect and submit all these data. However, the network of devices may not be available at operation time, for example because of a temporary network failure. At the same time, other devices in the area may be able to provide this information or pieces of this information. Citizens may carry smartphones with built-in sensors of temperature. Information may also be inferred through other mechanisms. For instance, the level of traffic may be inferred by capturing the background noise through mobile devices and/or by collecting the density of mobile devices in a particular road as a mechanism to extrapolate the level of traffic. Therefore, a large number of devices may be able to provide the same types of data. Another example may be alternative ways to calculate the number of passengers in a bus. The bus may be equipped with the necessary mechanisms to count the approximate number of passengers and to transmit this information when necessary. However, in case this equipment is not available, the number of passengers in a bus can be approximated through the density of mobile devices geo-located with the bus position and moving at the same time and speed. Besides, if devices are not available, questions can be crowdsourced to individuals able to provide this information. For instance, the system could ask application users in that particular area how they feel the temperature in a provided scale (cold, chilly, warm, etc) or what is the level of traffic in a particular street on which they are walking.

Although an initial task requesting temperature, humidity and pressure may be posted, there may not be a single device able to provide all these data in a particular area. According to various embodiments described herein, the thing-sourcing platform 110 may post the task including a set of conditions, for example, as was described at Block 220 of FIGS. 2 and 4. Examples of conditions may be that the temperature must be provided within a particular area or region, humidity must be must be provided within a particular area or region, pressure must be provided within a particular area or region, pollution must be provided within a particular area or region, etc. Conditions may also include quality constraints. For instance, the measured temperature error should not be larger than 2 degrees Celsius.

Different devices 120 may connect to the thing-sourcing platform 110 and match some of the conditions with a particular capacity of a device. For instance, a device may be able to provide temperature, but not humidity. Conditions may also be satisfied partially. The platform 110 may keep track of “best offer” so far, and/or keep a sorted list of received device offering so that if nothing better is available, the request conditions can be downgraded if necessary. This may depend on how the conditions are specified. For instance, some conditions may request the temperature in zone X with +/−2 degree precision on or before time Y. If after time Y, no feasible group can provide the information, drop (or relax) the precision constraint. If no group of devices can provide the required precision, traditional crowd-sourcing might be used to collect equivalent results, i.e., “if you are near the corner of 1st Ave., and Main St., text the temp and earn a point.” For example, a device may be able to provide pressure measurements, but the level of error may be larger than desired. In yet another example of lack of precision, measuring the level of traffic using geo-positioning information of mobile devices may not be reliable, as the geo-location precision may not be good and signals may correspond to pedestrians in a significantly crowded street. These devices would request participation in that particular task to the thing-sourcing platform. The application may also weight quality if the answer comes from an individual that provides an opinion through the platform. Thus, for example, the thing-sourcing platform 110 may try to select a subgroup of devices that is able to fulfill all the requested conditions as described, for example, at Block 240 of FIGS. 2, 4 and 9. Moreover, based on the lack of quality of a particular source, the system may decide to collect equivalent data from different sources and aggregate the data by computing the average.

### Further Definitions and Embodiments

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

The description herein has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed:

1. A method comprising:
posting requirements for a thing-sourcing project that comprises a thing-sourcing task, to thing-sourcing participant devices;
receiving from a first group of the thing-sourcing participant devices, electronic requests to participate in the task, wherein a respective electronic request identifies a portion of the task that can be accomplished by a respective thing-sourcing participant device, but none of the electronic requests indicate that the task can be accomplished entirely by any one of the first group of the thing-sourcing participant devices;
selecting from the first group of the thing-sourcing participant devices, a second group of the thing-sourcing participant devices that can collectively accomplish the task, even though none of the second group of the thing-sourcing participant devices can accomplish the task individually; and
coordinating execution of the thing-sourcing project by the second group of the thing-sourcing participant devices that can collectively accomplish the task, even though none of the second group of the thing-sourcing participant devices can accomplish the task individually.

2. The method according to claim 1:
wherein the posting is performed by a thing-sourcing platform that is connected to the thing-sourcing participant devices by a network,
wherein the receiving is performed by the thing-sourcing platform in response to the electronic requests that are received by the thing-sourcing platform from the first group of the thing-sourcing participant devices over the network,
wherein the selecting is performed by the thing-sourcing platform, and
wherein the coordinating is performed by the thing-sourcing platform.

3. The method according to claim 2 wherein the selecting comprises:
identifying a set of conditions that are required to accomplish the task; and
identifying respective subsets of the set of conditions that are satisfied by respective thing-sourcing participant devices in the first group of the thing-sourcing participant devices based on the respective portions of the task identified in the respective electronic requests, to identify the second group of the thing-sourcing participant devices that can collectively accomplish the set of conditions even though none of the second group of the thing-sourcing participant devices can accomplish the set of conditions individually.

4. The method according to claim 3, wherein the identifying respective subsets comprises:
identifying a subset of the set of conditions that is satisfied by a given device in the first group of the thing-sourcing participant devices;
determining whether the set of conditions is satisfied by the given device and any previously identified device in the first group of the thing-sourcing participant devices; and
performing the identifying and the determining for additional devices in the first group of the thing-sourcing participant devices, until the second group of the thing-sourcing participant devices has been identified.

5. The method according to claim 3, further comprising:
terminating the identifying respective subsets in response to the second group of the thing-sourcing participant devices being identified, even though the conditions that are satisfied by all of the first group of the thing-sourcing participant devices have not yet been identified.

6. The method according to claim 3, wherein the identifying respective subsets further comprises:
identifying largest subsets of the set of conditions that are satisfied by the respective thing-sourcing participant devices in the first group of the thing-sourcing participant devices to eliminate a member of the second group of the thing-sourcing participant devices that can only satisfy a smaller subset of the set of conditions.

7. The method according to claim 3, further comprising:
notifying members of the first group of the thing-sourcing participant devices that are not included in the second group of the thing-sourcing participant devices that they will not be participating in the thing-sourcing project.

8. The method according to claim 3, wherein the coordinating execution comprises:
identifying a plurality of subworkflows that are to be performed by respective thing-sourcing participant devices in the second group of the thing-source participant devices to accomplish the thing-sourcing task;
notifying the respective thing-sourcing participant devices in the second group of the thing-sourcing participant devices, of a respective subworkflow that is to be performed;
receiving over the network from the respective thing-sourcing devices of the second group of thing-sourcing participant devices, respective results of performing the respective subworkflow; and
combining the results from the second group of the thing-sourcing participants.

9. The method according to claim 8, wherein the notifying comprises allocating memory and processor resources of the thing-sourcing platform based on the respective subworkflows that are to be performed.

10. The method according to claim 2, wherein the posting is performed by the thing-sourcing platform in response to electronic input from a requestor device over the network.

11. The method according to claim 1, wherein the receiving and the selecting are performed to overlap in time.

12. The method according to claim 11, wherein the receiving is terminated upon completion of the selecting.

13. The method according to claim 2:
wherein at least one of the thing-sourcing participant devices comprises a user device that communicates with the thing-sourcing platform over the network in response to a user input; and
wherein at least one of the thing-sourcing participant devices comprises an electronic device that automatically communicates with the thing-sourcing platform over the network.

14. The method according to claim 13, wherein the electronic device automatically communicates with the thing-sourcing platform over the network using a software agent that is configured to negotiate with the thing-sourcing platform, the portion of the task that can be accomplished by the electronic device.

15. The method according to claim 13, wherein the electronic device comprises a thing in an Internet of Things (IoT).

16. A computer program comprising:
a computer readable storage medium having computer readable program code embodied in the medium, that is executable to cause a computer system to perform operations comprising:
posting requirements for a thing-sourcing project that comprises a thing-sourcing task, to thing-sourcing participant devices;
receiving from a first group of the thing-sourcing participant devices, electronic requests to participate in the task, wherein a respective electronic request identifies a portion of the task that can be accomplished by a respective thing-sourcing participant device, but none of the electronic requests indicate that the task can be accomplished entirely by any one of the first group of the thing-sourcing participant devices;
selecting from the first group of the thing-sourcing participant devices, a second group of the thing-sourcing participant devices that can collectively accomplish the task, even though none of the second group of the thing-sourcing participant devices can accomplish the task individually; and
coordinating execution of the thing-sourcing project by the second group of the thing-sourcing participant devices that can collectively accomplish the task, even though none of the second group of the thing-sourcing participant devices can accomplish the task individually.

17. The computer program product according to claim 16, wherein the selecting comprises:
identifying a set of conditions that are required to accomplish the task; and
identifying respective subsets of the set of conditions that are satisfied by respective thing-sourcing participant devices in the first group of the thing-sourcing participant devices based on the respective portions of the task identified in the respective electronic requests, to identify the second group of the thing-sourcing participant devices that can collectively accomplish the set of conditions even though none of the second group of the thing-sourcing participant devices can accomplish the set of conditions individually.

18. The computer program according to claim 16, wherein the identifying respective subsets further comprises:
identifying largest subsets of the set of conditions that are satisfied by the respective thing-sourcing participant devices in the first group of the thing-sourcing participant devices to eliminate members of the second group of the thing-sourcing participant devices that can only satisfy a smaller subset of the set of conditions.

19. A computer system comprising:
a processor; and
a memory coupled to the processor, the memory comprising computer readable program code embodied therein that is executable to cause the computer system to perform operations comprising:
posting requirements for a thing-sourcing project that comprises a thing-sourcing task, to thing-sourcing participant devices;
receiving from a first group of the thing-sourcing participant devices, electronic requests to participate in the task, wherein a respective electronic request identifies a portion of the task that can be accomplished by a respective thing-sourcing participant device, but none of the electronic requests indicate that the task can be accomplished entirely by any one of the first group of the thing-sourcing participant devices;
selecting from the first group of the thing-sourcing participant devices, a second group of the thing-sourcing participant devices that can collectively accomplish the task, even though none of the second group of the thing-sourcing participant devices can accomplish the task individually; and
coordinating execution of the thing-sourcing project using the second group of the thing-sourcing participant devices that can collectively accomplish the task, even though none of the second group of the thing-sourcing participant devices can accomplish the task individually.

20. The computer system according to claim 19, wherein the selecting comprises:
identifying a set of conditions that are required to accomplish the task; and
identifying respective subsets of the set of conditions that are satisfied by respective thing-sourcing participants in the first group of the thing-sourcing participant devices based on the respective portions of the task identified in the respective electronic requests, to identify the second group of the thing-sourcing participant devices that can collectively accomplish the set of conditions even though none of the second group of the thing-sourcing participant devices can accomplish the set of conditions individually.
